(19) United States
(12) Patent Application Publication
(10) Pub. No.: US 2026/0023671 A1
(43) Pub. Date: Jan. 22, 2026

(54) LOG ANOMALY DETECTION BASED ON GOLDEN SIGNAL TEMPLATES

(71) Applicant: International Business Machines Corporation, Armonk, NY (US)

(72) Inventors: Amitkumar Manoharrao Paradkar, YORKTOWN HEIGHTS, NY (US); Prateeti Mohapatra, Bangalore (IN); Jae-Wook Ahn, Yorktown Heights, NY (US); Meenakshi Madugula, San jose, CA (US); Pujitha Kara, San Jose, CA (US); Ian Manning, Cork (IE); Dipak Wani, San Jose, CA (US); Xiaotong Liu, San Jose, CA (US); Rupaningal Sarasi Sarangi Lalithsena, San Jose, CA (US); Neil H. Boyette, Oregon City, OR (US)

(21) Appl. No.: 18/776,188

(22) Filed: Jul. 17, 2024

(51) Int. Cl. G06F 11/07; G06F 11/30; G06F 40/242; G06F 40/279

(52) U.S. Cl. CPC G06F 11/3476; G06F 2201/88

(57) ABSTRACT

An example operation may include one or more of identifying instances of different log templates included in a log file based on execution of a machine learning (ML) model on the log file, filtering the different log templates based on a golden signal dictionary to identify log templates that correspond to golden signals, respectively, determining a count of instances of the log templates within the log file, and detecting an anomaly within the log file based on a comparison of the count of the instances of the log templates to baseline counts of the log templates.

### BACKGROUND

A computer log or log file often includes a stream of messages generated by a system in time sequence. Logs may be generated by network devices, operating systems, applications, programmable devices, and the like. A log may be directed to files and stored on a disk or other storage. Meanwhile, log analysis is a process of seeking to make sense of the content included in a log. Log analysis may be performed for security policy compliance, system troubleshooting, security incident response, understanding online user behavior, and the like.

### SUMMARY

One example embodiment provides a computer-implemented method that includes one or more of identifying instances of different log templates included in a log file based on execution of a machine learning (ML) model on the log file, filtering the different log templates based on a golden signal dictionary to identify log templates that correspond to golden signals, respectively, determining a count of instances of the log templates within the log file, and detecting an anomaly within the log file based on a comparison of the count of the instances of the log templates to baseline counts of the log templates.

Another example embodiment provides a computer system that may include a processor set, a set of one or more computer-readable storage media, and program instructions, collectively stored in the set of one or more storage media, for causing the processor set to perform computer operations to one or more of identify instances of different log templates included in a log file based on execution of a machine learning (ML) model on the log file, filter the different log templates based on a golden signal dictionary to identify log templates that correspond to golden signals, respectively, determine a count of instances of the log templates within the log file, and detect an anomaly within the log file based on a comparison of the count of the instances of the log templates to baseline counts of the log templates.

A further example embodiment provides a computer program product that may include a set of one or more computer-readable storage media, and program instructions. collectively stored in the set of one or more computer-readable storage media, for causing a processor set to perform computer operations including one or more of identifying instances of different log templates included in a log file based on execution of a machine learning (ML) model on the log file, filtering the different log templates based on a golden signal dictionary to identify log templates that correspond to golden signals, respectively, determining a count of instances of the log templates within the log file, and detecting an anomaly within the log file based on a comparison of the count of the instances of the log templates to baseline counts of the log templates.

### BRIEF DESCRIPTION OF THE DRAWINGS

FIG. 1 is a diagram illustrating a computing environment according to an embodiment of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3A is a diagram illustrating a process of analyzing log files for anomalies using golden signal templates according to examples and features of the instant solution.

FIG. 3B is another diagram illustrating a process of analyzing log files for anomalies using golden signal templates according to examples and features of the instant solution.

FIG. 3C is yet another diagram illustrating a process of analyzing log files for anomalies using golden signal templates according to examples and features of the instant solution.

FIG. 4A is a diagram illustrating a count of templates performed by a machine learning model according to examples of the features of the instant solution.

FIG. 4B is a diagram illustrating a process of mapping a log message to a template according to examples of the features of the instant solution.

FIG. 4C is a diagram illustrating a process of mapping golden signals to log templates according to examples of the features of the instant solution.

FIG. 5A illustrates a flow diagram, according to example embodiments.

FIG. 5B illustrates a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a log analyzer that can analyze log messages created by a monitored system using log templates that are matched with golden signals. In computing, golden signals are a set of key metrics which offer a wide view of a system's performance, reliability, and capacity. Examples of golden signals include error, latency, saturation, traffic, availability, exception, and the like. In the example embodiments, a log file may be identified and the log messages within the log file can be matched to log templates. The process may be performed using a machine learning model.

According to various embodiments, the machine learning model may match log messages in the log file to different log templates through a process referred to as templatization. The machine learning model may also track a count of instances of each log template from among the different log templates that appear in the log file. The log templates that are not matched to golden signals can be removed. The system may generate a table that includes identifiers of each log template and a number of counts of each log template in the log file. Furthermore, some of the log templates can be mapped to golden signals using a golden signal dictionary. The result is a subset of log templates mapped to log templates (referred to herein as golden signal log templates). The count of each golden signal log template can be analyzed by a second machine learning model to detect whether an anomaly has occurred.

In some embodiments, the logs that are analyzed may be from a cloud logging service; however, embodiments are not limited thereto.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based c-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

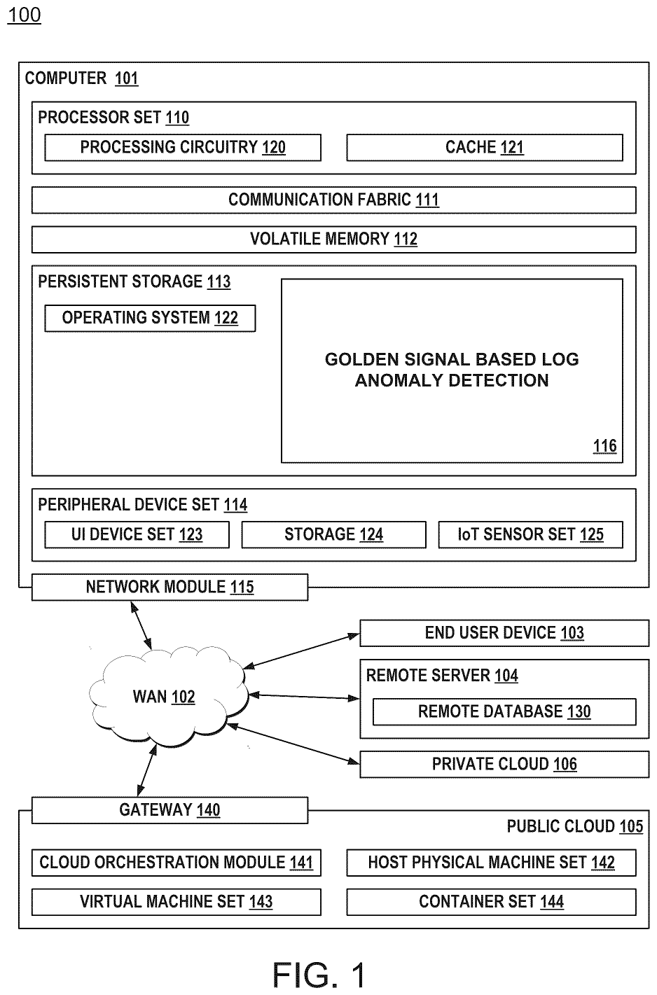

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a golden signal-based log anomaly detection system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The example embodiments are directed to a training platform for training a machine learning (ML) model such as a neural network, a deep neural network, or other AI model. The system can execute the ML model on a training sample of data during a feed forward process to generate a predicted output. Prior to performing a back propagation process, the predicted output can be compared to an expected output. Furthermore, a validation function can be applied to the comparison of the predicted output and the expected output to determine an accuracy of the ML model with respect to the training sample. When the accuracy is better than a threshold, the back propagation process can be skipped/omitted for this training sample because the ML model already has a good understanding of this example.

As an example, a validation function may be a validation metric, a mean validation metric, or the like, which can be applied to the comparison of the predicted model output to the expected output to determine the accuracy of the model. For example, a predicted output of the ML model for a training sample may be the number 5.2. The expected output for the training sample may be the number 5. Here, the difference is 0.2, or 96% accurate. The validation function may require the model to be at a threshold of at least 90% accurate. In this example, the model is above the 90% threshold. When the accuracy is better than a predefined threshold, the back propagation process can be skipped.

Detailed descriptions of the log analysis system using golden signals and the machine learning models in the instant solution are further described and depicted herein. In the examples below, the terms “machine learning model” and “artificial intelligence” model may be used interchangeably and should be understood to refer to both types of models.

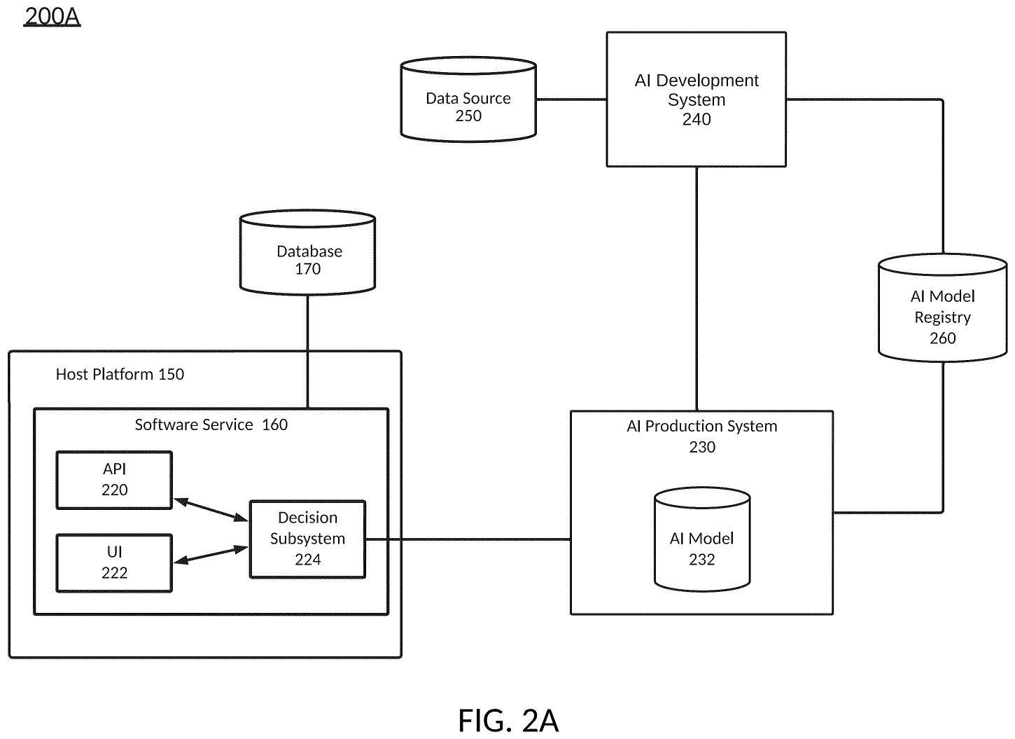

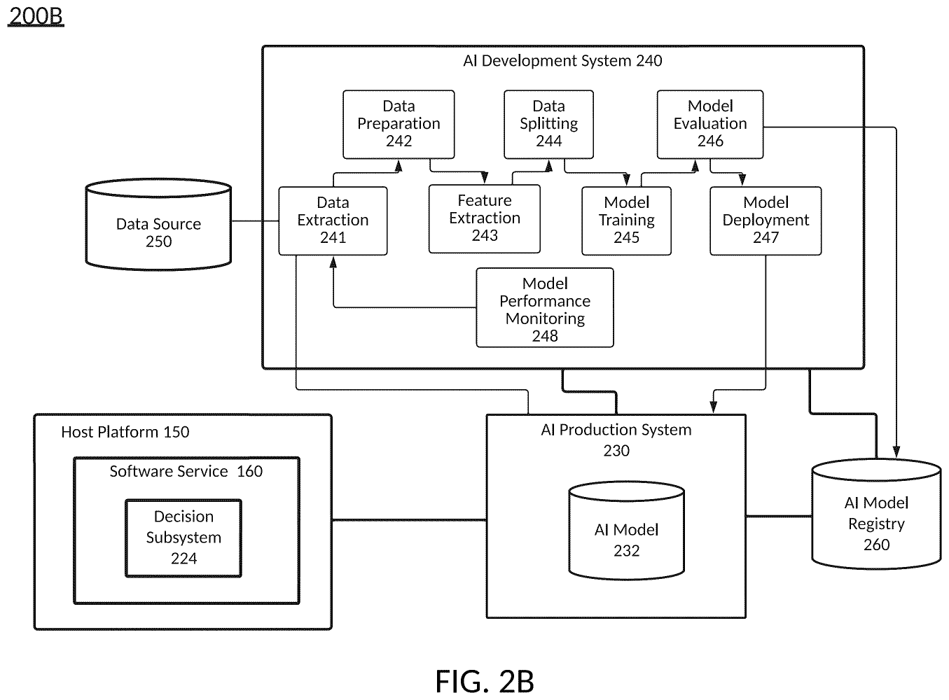

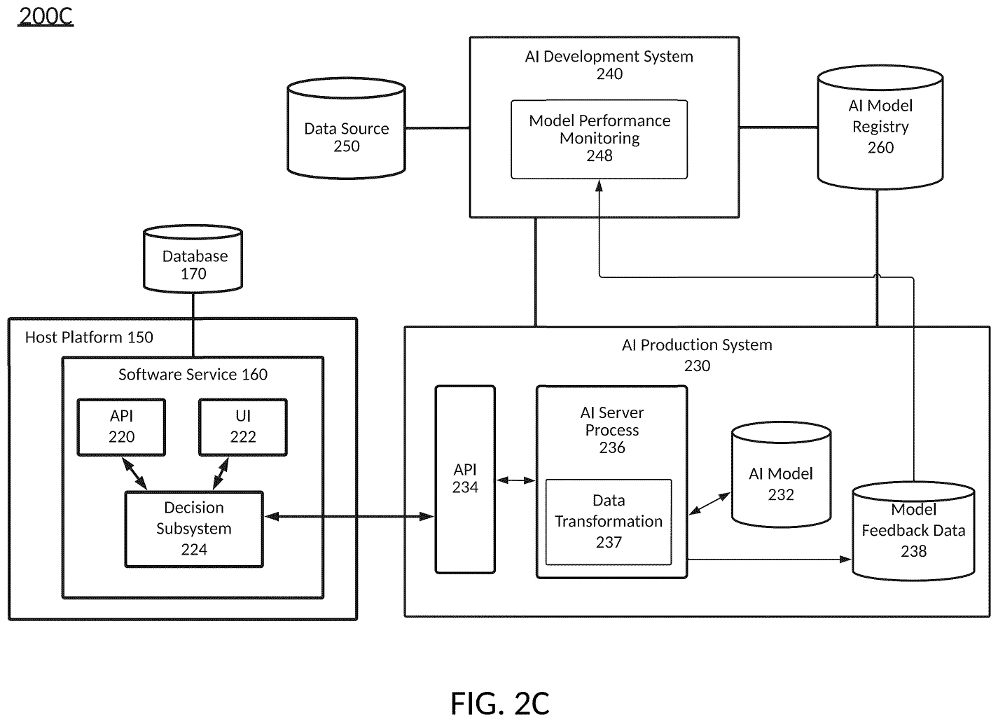

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 160 (see FIG. 2A), executing on host platform 150 (see FIG. 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 160 to assist in decision-making. In some examples and features of the instant solution, the software service 160 stores data included in API requests or data generated during processing the API requests into one or more databases 170 (see FIGS. 1, 2A).

Software service 160 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 160 to assist with decision-making. In some examples and features of the instant solution, the software service 160 stores data included in UI requests or data generated during processing the UI requests into one or more databases 170.

Software service 160 may include one or more decision subsystems 224 that drive a decision-making process of the software service 160. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 170 to aid in the decision-making process. A decision subsystem 224 may provide feedback to an API 220 or a UI 222.

An AI production system 230 may be used by a decision subsystem 224 in a software service 160 to assist in its decision-making process. The AI production system 230 includes one or more AI models 232 that are executed to generate a response, such as, but not limited to, a log message templatization, an anomaly detection, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

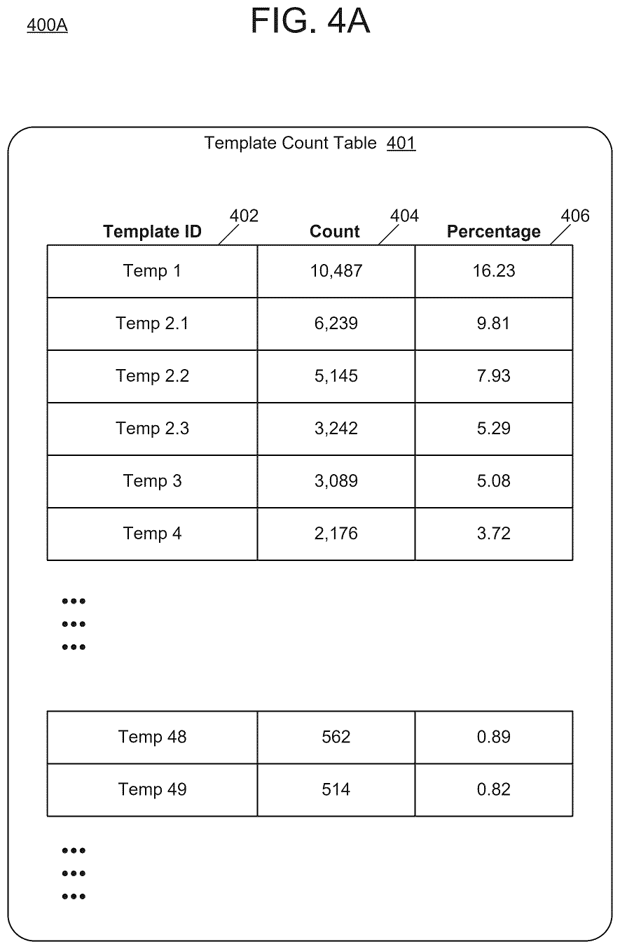

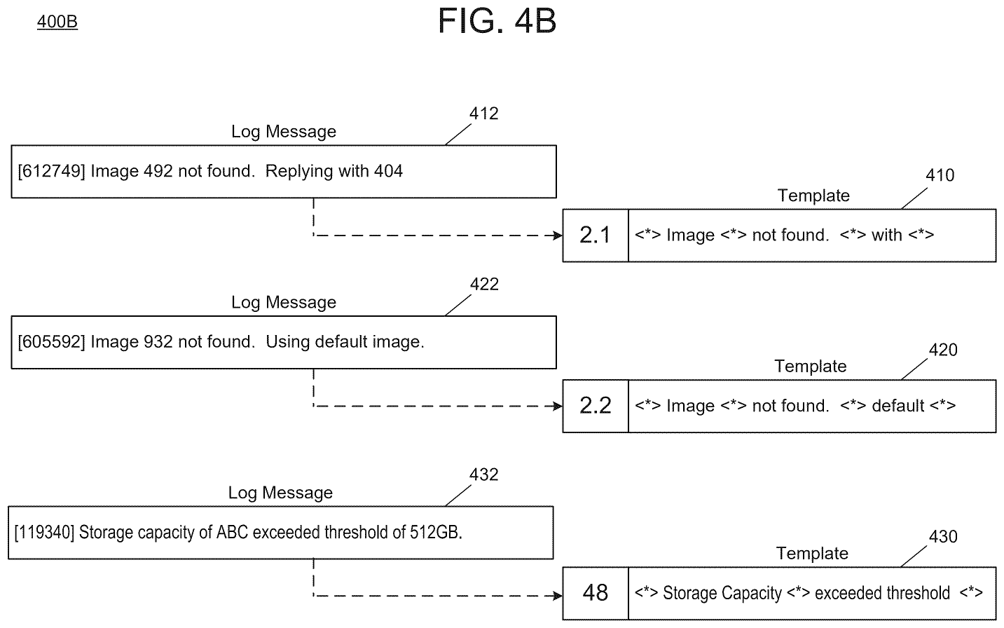

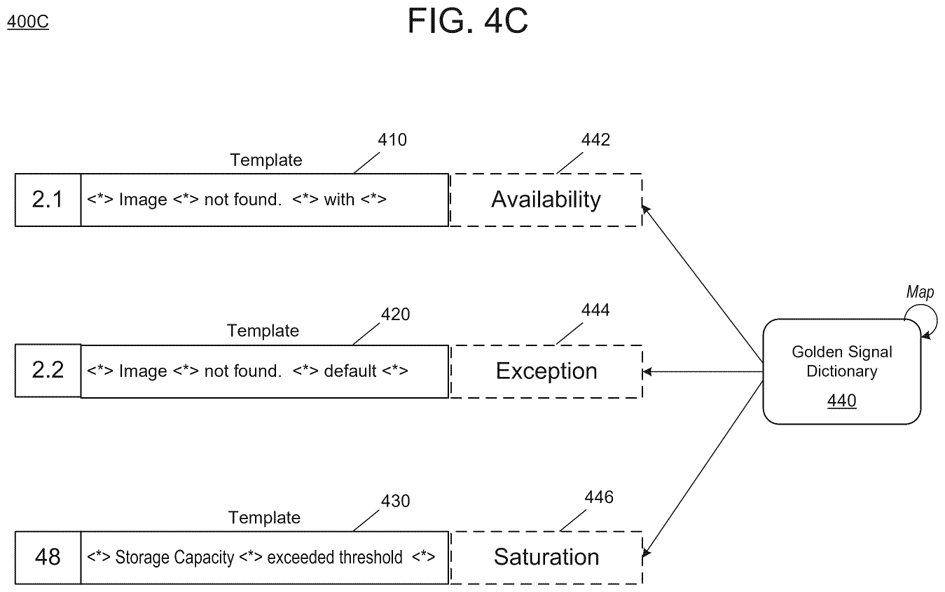

An AI development system 240 creates one or more AI models 232. In some examples and features of the instant solution, the AI development system 240 utilizes data from one or more data sources 250 to develop and train one or more AI models 232. Detailed examples of the training process according to example embodiments can be found in FIGS. 4A-4C, and the like. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 160 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 160, UI 222 data from software service 160 and/or data from other software service 160 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and/or enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 160. In some examples and features of the instant solution, the response may result in an update to a UI 222 in software service 160. In some examples and features of the instant solution, the response includes a request identifier that can be used later by the software service 160 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 and/or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

According to various embodiments, a system is provided that can derive metrics from log files for an anomaly detection pipeline. The metrics may be generated based on log templates. Log templates may be used to represent common message templates found in a log file. Some parts of the log template may be static and some may change per message. A machine learning model can be used to match log messages to log templates, and also count the number of instances of log messages that match to a particular log template. The result may include a respective count (e.g., instances of the respective log template, etc.) of a plurality of log templates included in the log file. A golden signal dictionary may be used to map the log templates to golden signals.

For example, the golden signal dictionary may be used to match a log template to a golden signal from among a plurality of golden signals based on one or more keywords within the static portion of the log template. The matching process may generate metrics including a count for each log template that maps to a golden signal, and an identifier of the golden signal that maps to the log template. Meanwhile, a second subset of log templates that are informational in nature (e.g., which do not match with a golden signal) may be removed from further consideration by the system. The metrics (e.g., the count of golden signal log templates) may be input to a second machine learning model which can detect whether an anomaly exists within the log file. The second machine learning model may compare the count of the golden signal log templates to predefined baselines for each of the templates which are learned by the model based on parameters such as time, season, etc. The baseline counts for each of the log templates may be learned during the training of the first machine learning model. The baseline may refer to the number of instances of the log template found in a particular log file. As another example, the baseline count may refer to the percentage of log templates found in the particular log file with respect to the other log templates such as the other golden signals, information, etc.

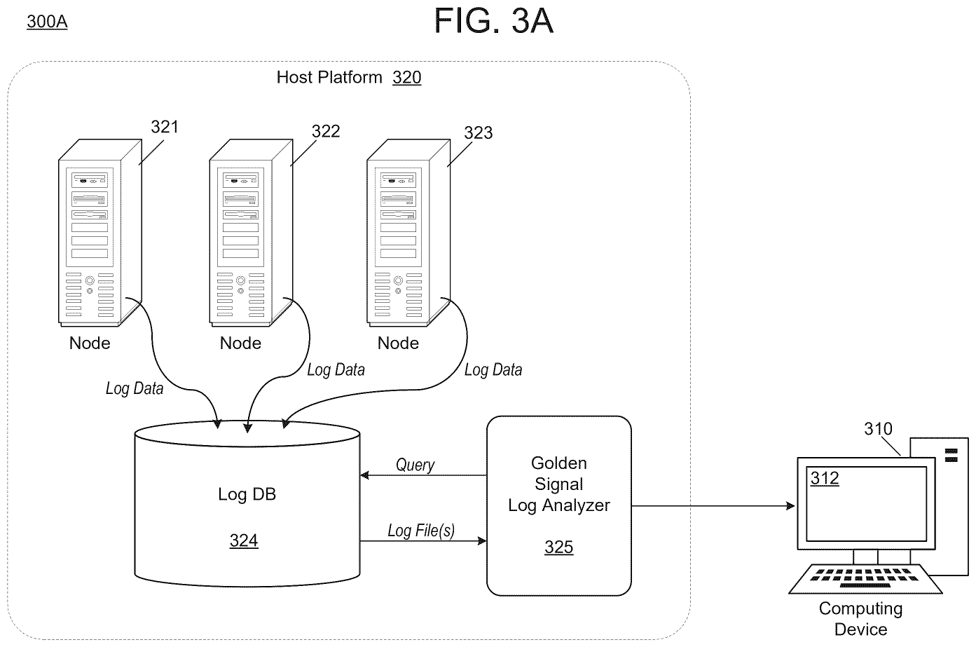

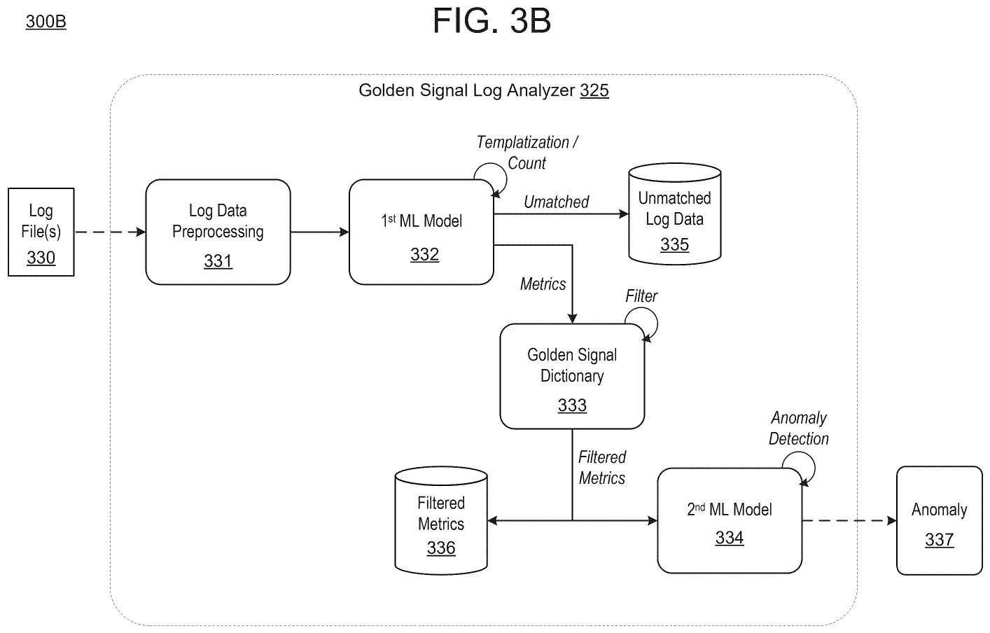

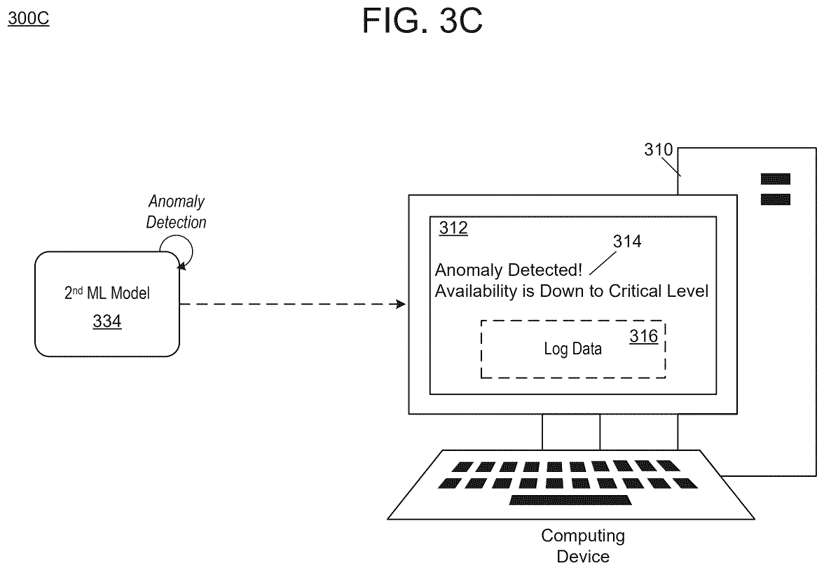

FIGS. 3A-3C illustrate a process of analyzing log files for anomalies using golden signal templates according to examples and features of the instant solution. For example, FIG. 3A illustrates a computing environment 300A where log files are generated and analyzed according to example embodiments. Referring to FIG. 3A, a host platform 320 may host a distributed system of nodes including a node 321, a node 322, and a node 323. In some embodiments, the host platform 320 may be a cloud platform, and the nodes may refer to processing nodes, virtual machines, or the like, hosted by the cloud platform. As another example, the host platform 320 may be a web server, or the like. Here, the node 321, the node 322, and the node 323 may generate log messages based on operations therein and send the log messages to a log database 324. The log database 324 may record the log messages in log files.

In the example of FIG. 3A, the node 321, the node 322, and the node 323 refer to computing nodes, but it should be appreciated that the example embodiments may receive log data from software applications, databases, network systems, or the like, and is not limited to a distributed computing environment.

The log data provided from the node 321, the node 322, and the node 323 may include messages that provide details about the operation of the systems and software associated therewith including, but not limited to, startup information, connections and system membership, distribution of data between system members, cache initialization, user data, and the like. The log data may be recorded in the log database 324 and analyzed through a golden signal log analyzer 325, according to example embodiments.

For example, the golden signal log analyzer 325 may analyze log files as they are stored within the log database 324, or may analyze log files based on requests received, for example, from a computing device 310. The computing device 310 may refer to an administrator computing device, such as a network admin, an IT professional, or the like, with a graphical user interface 312 running on the computing device 310 to facilitate interaction of the user with the programs described herein. The golden signal log analyzer 325 can derive metrics from log files and detect anomalies in the performance and/or operation of one or more of the nodes, the software running on the nodes, the user interactions with the nodes, and the like.

According to various embodiments, the metrics may be generated based on log templates. Log templates may be used to represent common message found in a log file. Some parts of the log template may be static and some may be dynamic/variable per message. A machine learning model can be used to match log messages to log templates, and also count the number of instances of log messages that match to a particular log template. The result may include a respective count (e.g., instances of the respective log template, etc.) of a plurality of log templates included in the log file. A golden signal dictionary may be used to map the log templates to golden signals.

In some embodiments, the templates may be pre-existing templates that have already been learned by the machine learning model. As another example, the log templates may be learned based on the log data input to the machine learning model. For example, the golden signal log analyzer 325 may generate a new template based on the identified static and variable portions of the received log messages. The golden signal log analyzer 325 may compute a metric for each log template based on a number of log messages within a log file that fall within a respective log template. The log analyzer reports a status in the monitored system based on the computed metric. In some embodiments, existing log templates may be used as a seed to create new log templates. In some embodiments, the golden signal log analyzer groups a set of related log messages and identifies a set of templates that the set of related log messages fall within as a template model. The log analyzer may add a particular template to the template model when one or more log messages of the set of related log messages fall within the particular template.

According to various embodiments, the golden signal log analyzer 325 may filter the log templates using a golden signal dictionary. Here, the golden signal log analyzer 325 may compare words within a static part of a log template to keywords in the golden signal dictionary to identify log templates that correspond to golden signals. For example, the log templatization process may identify 75 log templates from a log file. The golden signal log analyzer 325 may identify a small subset of log templates (e.g., 5, 10, 15, etc.) that correspond to golden signals, and remove the other log templates from further consideration by the system.

The matching process may be used to update the metrics including a count for each log template that maps to a golden signal, and an identifier of the golden signal that maps to the log template. Meanwhile, a second subset of log templates that are informational in nature (e.g., which do not match with a golden signal) may be removed from further consideration by the system. The metrics (e.g., the count of golden signal log templates) may be input to a second machine learning model which can detect whether an anomaly exists within the log file. The second machine learning model may compare the count of the golden signal log templates to predefined baselines for each of the templates which are learned by the model based on parameters such as frequency, time, season, etc.

FIG. 3B illustrates a process 300B performed by the golden signal log analyzer 325 when analyzing a log file according to example embodiments. Referring to FIG. 3B, the golden signal log analyzer 325 includes a log data preprocessing module 331, a first machine learning model 332, a golden signal dictionary 333, and a second machine learning model 334. In this example, the log data preprocessing module 331 may receive at least one log file 330 from the log database 324 shown in FIG. 3A. The log data preprocessing module 331 may parse the at least one log file 330, unroll any nested structures, perform formatting of the log messages, and the like. The pre-processed log data may be provided to the first machine learning model 332.

According to various embodiments, the first machine learning model 332 may perform templatization of the log data. The templatization process may detect log templates from within the log data, such as pre-existing log templates and/or new log templates. The templatization process may also count each occurrence of a log template within the log data to generate metrics that include log templates paired with their counts. The log templates may also be identified with a log template identifier. The initial metrics may be stored within a table such as the template count table 401 shown in the example of FIG. 4A.

Referring to FIG. 4A, shown is a process 400A of generating a template count table 401 that includes a column 402 identifying template logs, a column 404 identifying a count of the template logs in the log data, and a column 406 indicating the overall percentage of the log template with respect to other log templates in the log file. The template count table 401 may be the initial metrics that are generated by the golden signal log analyzer 325. The first machine learning model 332 may generate the template count table 401 as an output, based on the input log data from the log data preprocessing module 331.

FIG. 4B illustrates a process 400B of determining a log template from a log message according to example embodiments. Referring to FIG. 4B, the first machine learning model 332 shown in FIG. 3B may determine the log templates based on the log data, or it may use pre-existing log templates. In the example of FIG. 4B, the first machine learning model 332 newly generates a log template 410, a log template 420, and a log template 430, based on the input log data. For example, the log template 410 may be identified based on the training of the first machine learning model 332. For example, the first machine learning model 332 may be trained using dictionaries of log templates, pre-existing log templates, and the like. Thus, the first machine learning model 332 can recognize new log templates.

Here, a log message 412 is analyzed by the first machine learning model 332 which detects a static part and a dynamic part. For example, the dynamic part of the log message 412 may include the terms “[612749]”, “492”, “Replying”, and “404”, while the remaining part of the log message 412 (e.g., “Image . . . not found . . . with . . . ” is the static part of the log message 412. Here, the first machine learning model 332 may generate the log template 410 based on the static part of the log message 412, without the dynamic part of the log message 412.

In addition, a log message 422 may be analyzed by the first machine learning model 332 which detects a static part and a dynamic part. For example, the dynamic part of the log message 422 includes the terms “[605592]”, “932”, “Using”, and “image”, and the static part of the log message 422 includes the terms “Image . . . not found . . . default . . . ”. Again, the first machine learning model 332 may generate the log template 420 based on the static part of the log message 422 without the dynamic part of the log message 422.

Furthermore, a log message 432 may be analyzed by the first machine learning model 332 which detects a static part and a dynamic part. For example, the dynamic part of the log message 432 includes the terms “[119340]”, “of ABC”, and “of 512 GB”, and the static part of the log message 432 includes the terms “Storage capacity . . . exceeded threshold . . . ” Again, the first machine learning model 332 may generate the log template 430 based on the static part of the log message 432 without the dynamic part of the log message 432. In addition, the first machine learning model 332 may also count the number of instances/occurrences of log messages in the log data that match each of the respective log templates.

Returning again to FIG. 3B, the log data that is not able to be matched to a log template may be provided to an unmatched log data store 335. The unmatched log data can be used for further training/retraining of the first machine learning model 332, for example, as discussed in the examples of FIGS. 2A-2C. The matched log data (e.g., the log templates, the counts, and the identifiers of the log templates) may be filtered using a golden signal dictionary 333. Here, the golden signal dictionary 333 may be used to identify a subset of the log templates identified by the first machine learning model 332 from the log data which correspond to known golden signals using rules, keywords, etc. within the golden signal dictionary 333 in comparison to words included in the log templates (e.g., the static part of the log message, etc.) The golden signal dictionary 333 may be used to add an additional label to the metrics generated by the first machine learning model 332, which labels the log templates as being associated with a particular golden signal.

For example, FIG. 4C illustrates a process 400C of filtering log templates using the golden signal dictionary 333, according to example embodiments. Referring to FIG. 4C, the golden signal log analyzer 325 may compare the log template 410 to dictionary data within the golden signal dictionary 440 to identify a golden signal 442 that corresponds to the log template 410. Here, the golden signal “Availability” is matched to the log template 410 based on the keywords “not found” and “with”. Likewise, the golden signal dictionary 440 identifies a golden signal 444 that corresponds to the log template 420 based on the keyword “default” included in the log template 420. In addition, the golden signal dictionary 440 identifies a golden signal 446 that corresponds to the log template 430 based on the keywords “storage”, “exceeded”, and “threshold” included in the log template 430. Updated metrics can be added to the table shown in FIG. 4A, and log templates that are not related to golden signals, such as informational log templates, may be removed. The resulting updated metrics may be input to the second machine learning model 334. In addition, the resulting updated metrics may be provided to a filtered metrics data store 336. The filtered metrics data store 336 may hold training data for retraining the second machine learning model 334 to learn from the newly identified log templates and the counts identified for baseline purposes. The retraining process may be performed based on the examples described with respect to FIGS. 2A-2C.

Referring again to FIG. 3B, the second machine learning model 334 may receive the golden signal log templates, and the counts of each, and determine whether an anomaly exists within the log data. Here, the second machine learning model 334 may be trained on normal baseline data of a system thereby learning what is a normal amount of golden signal log templates for the particular system. When a baseline of any of the golden signal log templates is exceeded by a threshold, for a period of time, or the like, the second machine learning model 334 may detect an anomaly 337.

As described herein an anomaly may refer to a pattern of golden signal log templates that deviates from normal conditions. The second machine learning model 334 may detect/raise an anomaly when the incoming log template metric counts are significantly different than the baseline model. The second machine learning model 334 may take into account the previous anomalous cases and identify cases like seasonality and drift.

For example, the second machine learning model 334 may perform a dynamic calculation of baseline values for each metric. For example, a metric baseline might be within the 1 to 25 range at a particular time of day. If a metric value is returned outside of this range, then a metric anomaly alert may be generated and displayed. For example, FIG. 3C illustrates a process 300C of generating and displaying an alert 314 on a graphical user interface (GUI) 312 of the computing device 310. Here, the alert 314 identifies the anomaly related to the golden signal (availability) and provides log data 316 associated with the anomaly on the GUI 312. The log data 316 may include content from the log messages, the log template, the baseline data, and the like, which may be determined by the second machine learning model 334.

Anomalies may be detected through various examples including a simple baseline comparison, where less than 50% of data is available for a time series when training occurs, or the analytics determines that a dynamic baseline is not a good fit for a particular time series. After the analytics training for the second machine learning model 334 occurs, the second machine learning model 334 may raise alerts when values exist outside the simple baseline. Before the analytics training occurs, values can fall outside the simple baseline and not raise an alert. Another example is flatlining, whereby the second machine learning model 334 may identify that the metric started unexpectedly returning a constant value. Another example anomaly detection scheme is finite domain, whereby the system detects an anomaly when a metric value elevates to a level not reached previously. Another example of an anomaly detection scheme is predominant range, whereby the system detects an anomaly when the variation in a metric value exceeds the range within which the metric normally varies. Another example is a metric with learned variance and that is later found to vary significantly is also flagged as a metric anomaly alert.

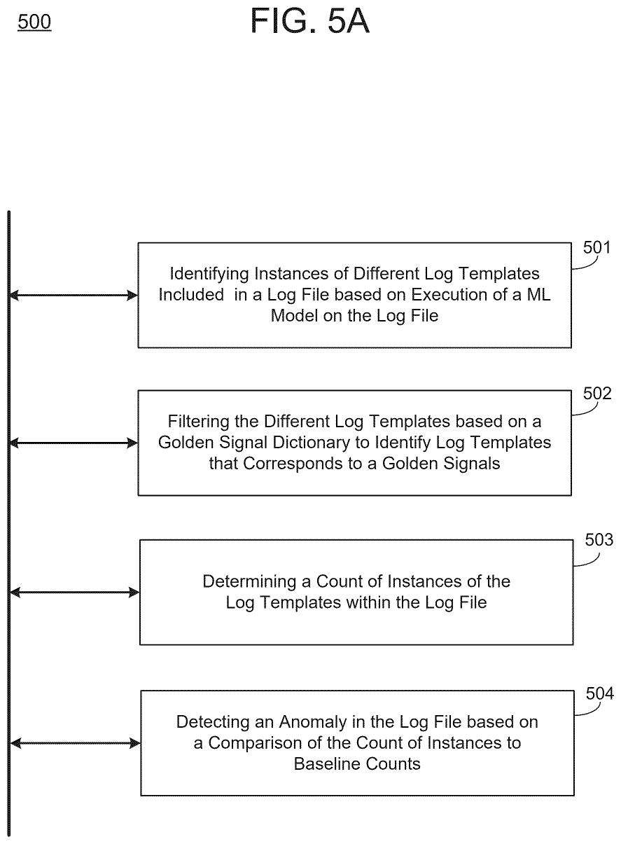

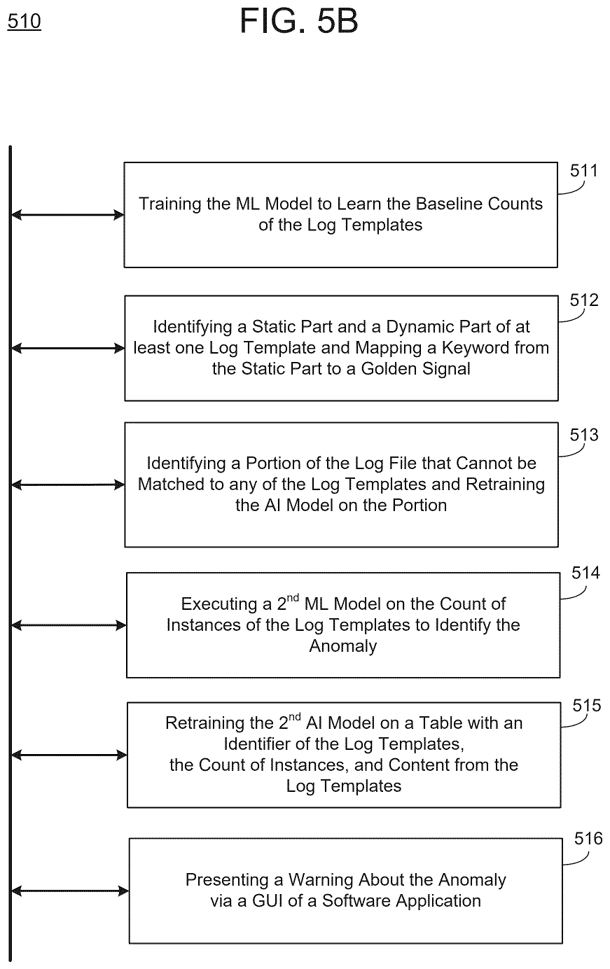

FIG. 5A illustrates a flow diagram of a method 500, according to example embodiments. Referring to FIG. 5A, the method 500 may include identifying instances of different log templates included in a log file based on execution of a ML model on a log file in 501. In 502, the method may include filtering the different log templates based on a golden signal dictionary to identify log templates that correspond to golden signals, respectively. In 503, the method may include determining a count of instances of the log templates within the log file. In 504, the method may include detecting an anomaly within the log file based on a comparison of the count of the instances of the log templates to baseline counts of the log templates.

FIG. 5B illustrates a flow diagram of a method 510, according to example embodiments. Referring to FIG. 5B, the method 510 may include training the ML model to identify the log templates from log content based on historical logs of content, wherein the training the ML model includes training the ML model to learn the baseline counts of the log templates, respectively, in 511. In some embodiments, the method may include identifying a static part and a dynamic part of at least one log template, and mapping at least one keyword from the static part of the at least one log template to a golden signal using the golden signal dictionary in 512. In 513, the method may further include identifying a portion of the log file that cannot be matched to any of the plurality of log templates based on the execution of the ML model, and retraining the ML model based on the portion of the log file that cannot be matched.

In 514, the method may further include training a second ML model to detect anomalies based on the baseline counts of the plurality of log templates corresponding to the plurality of golden signals, and executing the second ML model on the count of the baseline counts to detect the anomaly. In 515, the method may further include generating a table that includes an identifier of each of the log templates that corresponds to the golden signals, respectively, an identifier of a count of each log template in the log file, and content from each log template, and retraining the second ML model based on the table. In 516, the method may further include presenting a warning about the anomaly via a graphical user interface (GUI) of a software application.

In some embodiments, the method may further include training a second ML model to detect anomalies based on baseline counts of instances of log templates that correspond to golden signals, and executing the second ML model on the count of the instances of the at least one log template that corresponds to the golden signal within the log file to detect the anomaly in 514. In some embodiments, the method may further include generating a table that includes an identifier of the at least one log template that corresponds to the golden signal, an identifier of the count of instances of the at least one log template in the log file, and content from the at least one log template, and retraining the second ML model based on the table in 515. In some embodiments, the method may further include presenting a warning about the anomaly via a graphical user interface (GUI) of a software application in 516.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
identifying instances of different log templates included in a log file based on execution of a machine learning (ML) model on a log file;
filtering the different log templates based on a golden signal dictionary to identify log templates that correspond to golden signals, respectively;
determining a count of instances of the log templates within the log file; and
detecting an anomaly within the log file based on a comparison of the count of the instances of the log templates to baseline counts of the log templates.

2. The computer-implemented method of claim 1, further comprising training the ML model to identify the log templates from log content based on historical logs of content, wherein the training the ML model comprises training the ML model to learn the baseline counts of the log templates, respectively.

3. The computer-implemented method of claim 1, wherein the filtering comprises identifying a static part and a dynamic part of at least one log template, and mapping at least one keyword from the static part of the at least one log template to a golden signal using the golden signal dictionary.

4. The computer-implemented method of claim 1, wherein the identifying further comprises identifying a portion of the log file that cannot be matched to any of the different log templates based on the execution of the ML model, and retraining the ML model based on the portion of the log file that cannot be matched.

5. The computer-implemented method of claim 1, further comprising training a second ML model to detect anomalies based on the baseline counts of the log templates corresponding to the golden signals, and executing the second ML model on the count of the baseline counts to detect the anomaly.

6. The computer-implemented method of claim 5, further comprising generating a table that includes an identifier of each of the log templates that corresponds to the golden signals, respectively, an identifier of a count of each log template in the log file, and content from each log template, and retraining the second ML model based on the table.

7. The computer-implemented method of claim 1, further comprising presenting a warning about the anomaly via a graphical user interface (GUI) of a software application.

8. A computer system comprising:
a processor set;
a set of one or more computer-readable storage media; and
program instructions, collectively stored in the set of one or more storage media, for causing the processor set to perform computer operations to:
identify instances of different log templates included in a log file based on execution of a machine learning (ML) model on a log file,
filter the different log templates based on a golden signal dictionary to identify log templates that correspond to golden signals, respectively,
determine a count of instances of the log templates within the log file, and
detect an anomaly within the log file based on a comparison of the count of the instances of the log templates to baseline counts of the log templates.

9. The computer system of claim 8, wherein the computer operations further comprise training the ML model to identify the log templates from log content based on historical logs of content, wherein the training comprises training the ML model to learn the baseline counts of the log templates, respectively.

10. The computer system of claim 8, wherein the processor set is configured to identify a static part and a dynamic part of at least one log template, and map at least one keyword from the static part of the at least one log template to a golden signal using the golden signal dictionary.

11. The computer system of claim 8, wherein the processor set is configured to identify a portion of the log file that cannot be matched to any of the different log templates based on the execution of the ML model, and retrain the ML model based on the portion of the log file that cannot be matched.

12. The computer system of claim 8, wherein the computer operations further comprise training a second ML model to detect anomalies based on the baseline counts of the log templates corresponding to the golden signals, and executing the second ML model on the count of the baseline counts to detect the anomaly.

13. The computer system of claim 12, wherein the computer operations further comprise generating a table that includes an identifier of each of the log templates that corresponds to the golden signals, respectively, an identifier of a count of each log template in the log file, and content from each log template, and retraining the second ML model based on the table.

14. The computer system of claim 8, wherein the computer operations further comprise presenting a warning about the anomaly via a graphical user interface (GUI) of a software application.

15. A computer program product comprising:
a set of one or more computer-readable storage media; and
program instructions, collectively stored in the set of one or more computer-readable storage media, for causing a processor set to perform computer operations comprising:
identifying instances of different log templates included in a log file based on execution of a machine learning (ML) model on the log file,
filtering the different log templates based on a golden signal dictionary to identify log templates that correspond to golden signals, respectively,
determining a count of instances of the log templates within the log file, and
detecting an anomaly within the log file based on a comparison of the count of the instances of the log templates to baseline counts of the log templates.

16. The computer program product of claim 15, wherein the computer operations further comprise training the ML model to identify the log templates from log content based on historical logs of content, wherein the training the ML model comprises training the ML model to learn the baseline counts of the log templates, respectively.

17. The computer program product of claim 15, wherein the filtering comprises identifying a static part and a dynamic part of at least one log template, and mapping at least one keyword from the static part of the at least one log template to a golden signal using the golden signal dictionary.

18. The computer program product of claim 15, wherein the identifying further comprises identifying a portion of the log file that cannot be matched to any of the different log templates based on the execution of the ML model, and retraining the ML model based on the portion of the log file that cannot be matched.

19. The computer program product of claim 15, wherein the computer operations further comprise training a second ML model to detect anomalies based on the baseline counts of the log templates corresponding to the golden signals, and executing the second ML model on the count of the baseline counts to detect the anomaly.

20. The computer program product of claim 19, wherein the computer operations further comprise generating a table that includes an identifier of each of the log templates that corresponds to the golden signals, respectively, an identifier of a count of each log template in the log file, and content from each log template, and retraining the second ML model based on the table.
